(19) United States
(12) Patent Application Publication
(10) Pub. No.: US 2005/0099929 A1
(43) Pub. Date: May 12, 2005

(54) Optical disk

(75) Inventors: Tsuyoshi Yamamoto, Ota-shi (JP); Katsuki Hattori, Kiryu-shi (JP); Shinji Kobayashi, Ibi-gun (JP); Hiroshi Watanabe, Anpachi-gun (JP); Masato Fuma, Ichinomiya-shi (JP); Akira Tsukihashi, Ora-gun (JP)

Correspondence Address: PILLSBURY WINTHROP LLP, 725 S. FIGUEROA STREET, SUITE 2800, LOS ANGELES, CA, 90017, US

(73) Assignee: Sanyo Electric Co., Ltd., Osaka (JP)

(21) Appl. No.: 10/986,050

(22) Filed: Nov. 10, 2004

(30) Foreign Application Priority Data
Nov. 11, 2003 (JP) 2003-380612

(51) Int. Cl. G11B 3/74

(52) U.S. Cl. 369/94; 369/108

(57) ABSTRACT

An optical disk to which a laser ray irradiated from an optical pickup device equipped in an optical disk recording and replaying apparatus is incident, comprises two signal layers including a first signal layer and a second signal layer formed from a light incident surface side, wherein a visible image can be formed in the second signal layer (1D) by a laser ray irradiated from the light incident surface side.

### CROSS-REFERENCE TO RELATED APPLICATIONS

The priority Japanese Patent Application Number 2003-380612 upon which this patent application is based is hereby incorporated by reference.

### BACKGROUND OF THE INVENTION

1. Field of the Invention

The present invention relates to an optical disk in which a visible image can be formed on the disk using a laser ray irradiated from an optical pickup device.

2. Description of the Related Art

Disk players in which signals recorded on a disk are read using an optical pickup device are widely in use. Recently, optical disk recording and replaying apparatuses having a functionality to record signals onto a disk using a laser ray irradiated from an optical pickup device in addition to the replaying function have been commercialized.

When a signal is recorded on a disk using an optical disk recording and replaying apparatus, in order to see the contents of the signals recorded on the disk, it is necessary to replay the signals recorded on the disk. In order for a user to see the contents without replaying the signals, after the recording operation of signals is completed, the user must attach, for example, a label or the like indicating the recorded contents, for example, the name of a song when the recorded content is music, on a surface opposite to the recording surface on the disk, or write the name of the song or the like with a marking pen or the like on the surface opposite to the recording surface.

Attaching a label or the like or writing the name of the song or the like not only requires labor, but may also adversely affect replay of signals recorded on the disk. As a method for solving this problem, Japanese Patent Laid-Open Publication No.2003-203348 discloses a technique for forming a visible image on a photosensitive surface of the optical disk using a laser ray.

Japanese Patent Laid-Open Publication No. 2003-272240 discloses a technique which allows for the visible image to be formed in color.

Because, in a related art, a visible image is formed on a signal surface onto which the data signals are recorded, when the amount of recorded data signals is increased, the size of a region to which the visible image is to be formed is reduced, and there is a problem in that not all of the recorded data signals can be shown with the visible image. In addition, because the formation operation of the visible image on the optical disk is performed with respect to a surface opposite to the signal recording surface of the disk, the user must perform an operation to flip the disk over after the recording operation to the disk is completed, resulting in a problem that the operability is low.

### SUMMARY OF THE INVENTION

According to one aspect of the present invention, there is provided an optical disk comprising two signal layers including a first signal layer and a second signal layer from the side of a light incident surface onto which a laser ray irradiated from an optical pickup device equipped in an optical disk recording and replaying apparatus is incident, wherein a visible image can be formed in the second signal layer using a laser ray irradiated from the side of the light incident surface.

### BRIEF DESCRIPTION OF THE DRAWINGS

FIG. 1 is a cross sectional view showing an optical disk according to a preferred embodiment of the present invention.

FIG. 2 is a block circuit diagram showing an optical disk recording and replaying apparatus which uses an optical disk according to a preferred embodiment of the present invention.

FIG. 3 is a cross sectional view showing an optical disk according to another preferred embodiment of the present invention.

### DESCRIPTION OF PREFERRED EMBODIMENTS

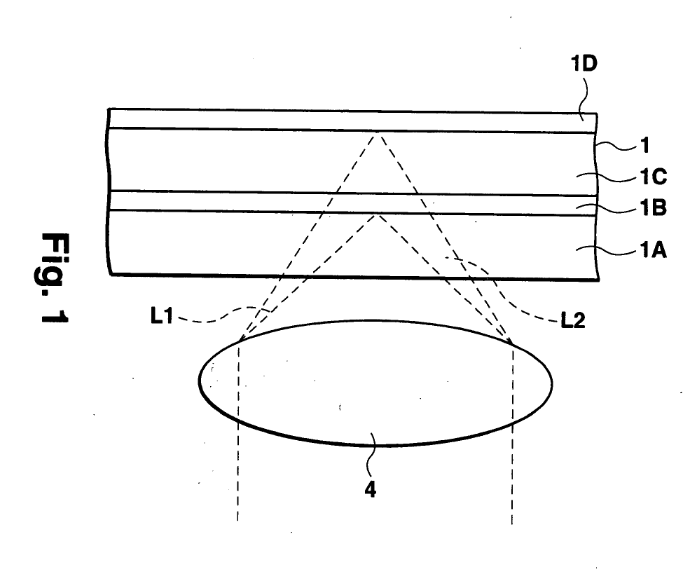

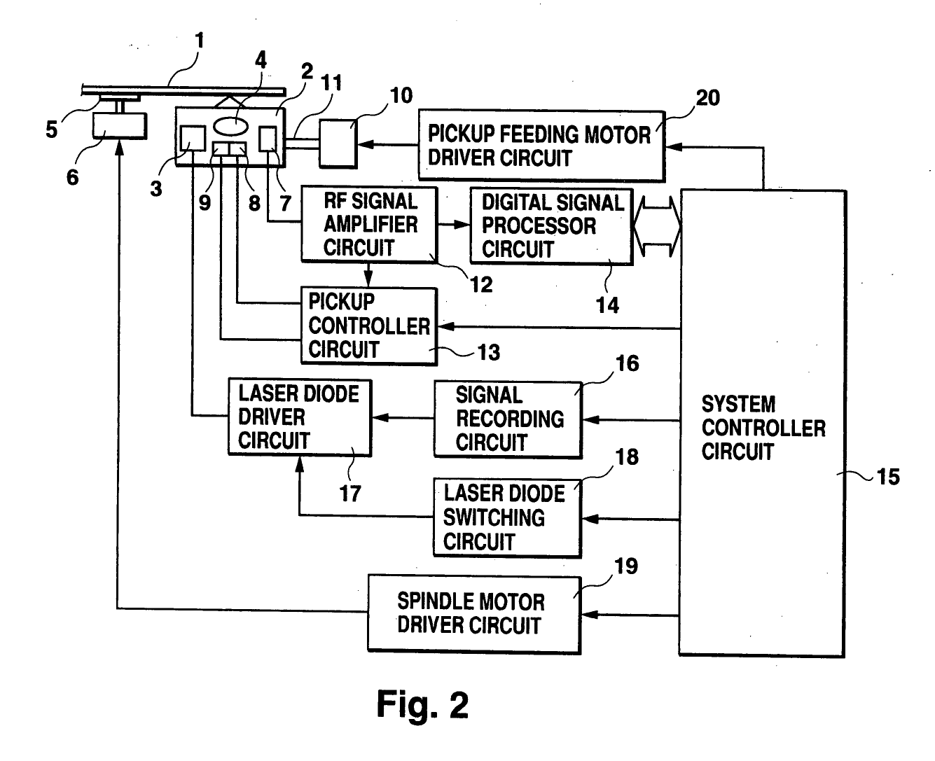

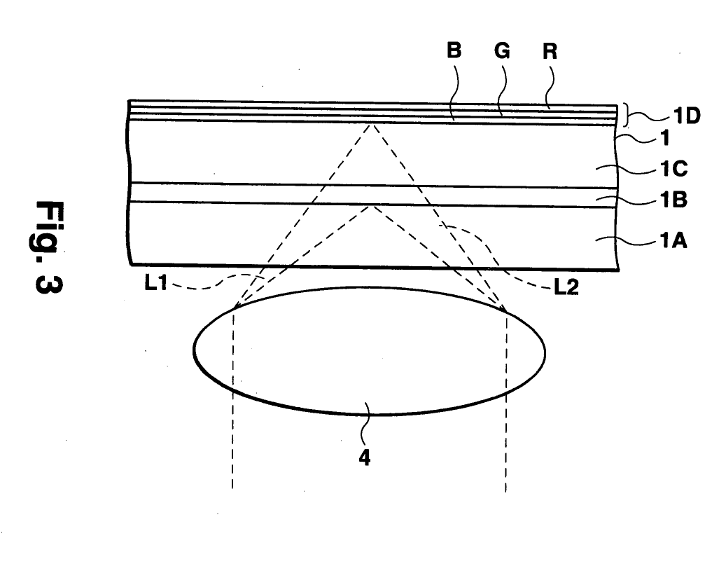

FIG. 1 is a cross sectional view of an optical disk according to a first preferred embodiment of the present invention. FIG. 2 is a block circuit diagram showing an optical disk recording and replaying apparatus which uses an optical disk according to the first preferred embodiment of the present invention. FIG. 3 is a cross sectional view showing an optical disk according to a second preferred embodiment of the present invention.

As shown in FIG. 1, an optical disk 1 according to the first preferred embodiment of the present invention comprises a first protective layer 1A which is transparent, a first signal layer 1B, a second protective layer 1C which is transparent, and a second signal layer 1D, formed from the side of a light incident surface to which a laser ray irradiated from a laser diode 3 equipped in an optical pickup device 2 is incident. The laser diode 3 equipped in the optical pickup device 2 is a dual-wavelength laser which irradiates two laser rays L1 and L2 having differing wavelengths. When the wavelength of the laser ray L1 is shorter than the wavelength of the laser ray L2, as shown in FIG. 1, the laser ray L1 is focused in the first signal layer 1B due to a focusing function of an objective lens 4 and the laser ray L2 is focused in the second signal layer 1D due to the focusing function of the objective lens 4.

In this configuration, by setting the second signal layer 1D as a signal recording layer, setting the laser ray L2 having a longer wavelength as the laser ray to be irradiated from the laser diode 3, and performing adjustment operations of a power level of the laser and of a position of irradiation, it is possible to form a visible image in the second signal layer 1D.

As shown in the block circuit diagram of FIG. 2, an optical disk recording and replaying apparatus according to the first preferred embodiment of the present invention is constructed such that a turntable 5 onto which the optical disk 1 is mounted is rotationally driven by a spindle motor 6. An optical detector 7 equipped in the optical pickup device 2 is irradiated with a laser ray reflected from the first signal layer 1B or from the second signal layer 1D of the optical disk 1 and converts the laser ray into an electrical signal.

A focusing coil 8 equipped in the optical pickup device 2 displaces the objective lens 4 in a direction toward or away from the signal surface of the optical disk 1 to focus the laser rays L1 and L2 to the respective signal layers. A tracking coil 9 equipped in the optical pickup device 2 displaces the objective lens 4 in a direction along a radius of the optical disk so that the laser rays L1 and L2 follow a signal track formed on the signal layers.

A motor 10 for feeding the pickup device is constructed to rotationally drive a feed screw 11 to move the body of the optical pickup device 2 in a direction along a radius of the optical disk 1. An RF signal amplifier circuit 12 receives an RF (radiofrequency) signal converted by the optical detector 7 into an electrical signal, amplifies the input signal, adjusts the waveform, and outputs a binarized signal.

A pickup controller circuit 13 applies a focus control operation and a tracking control operation based on a focus error signal and a tracking error signal obtained through the RF signal amplifier circuit 12. The pickup controller circuit 13 is configured to supply a drive signal to a focusing coil 8 and to a tracking coil 9 equipped in the optical pickup device 2.

A digital signal processor circuit 14 to which a binarized signal output from the RF signal amplifier circuit 12 is input is constructed to apply a digital signal process to a signal read from the optical disk 1 to extract a necessary data signal. A system controller circuit 15 for controlling various operations of the optical disk recording and replaying apparatus receives an input of an instruction signal and a data signal which is the signal to be recorded, which are output from a host device (not shown) such as a computer. The system controller circuit comprises a buffer memory (not shown) for temporarily storing a data signal.

A signal recording circuit 16 receives a data signal output from the host device and a data signal for a visible image and outputs a recording signal based on each of the input signals. The signal recording circuit 16 is configured to output a pulse signal for recording a data signal and a pulse signal for forming a visible image. A laser diode driver circuit 17 is configured to receive an input of a pulse signal output from the signal recording circuit 16 and to supply a drive signal corresponding to the input pulse signal to the laser diode 3 equipped in the optical pickup device 2.

A laser diode switching circuit 18 is configured to switch the laser diode driver circuit 17 so that a laser ray L1 having a shorter wavelength is output when the first signal layer 1B provided on the optical disk 1 is to be used and a laser ray L2 having a longer wavelength is output when the second signal layer 1D is to be used.

An operation of the spindle motor driver circuit 19 is controlled by the system controller circuit 15 and the spindle motor driver circuit 19 is configured to rotationally drive and control the spindle motor 6. The rotational drive and control operation of the spindle motor 6 by the spindle motor driver circuit 19 is configured such that, when a data signal is to be recorded on the optical disk 1, the optical disk 1 is rotationally driven at a constant linear speed using a synchronization signal read from the optical disk 1 and, when a visible image is to be formed, the optical disk 1 is rotationally driven at a constant angular speed. An operation of a pickup feeding motor driver circuit 20 is controlled by the system controller circuit 15 and the pickup feeding motor driver circuit 20 is configured to rotationally drive the pickup feeding motor 10.

Operation will now be described. When a data signal transmitted from the host device is to be recorded in the first signal layer 1B provided in the optical disk 1, the system controller circuit 15 applies a control operation to the laser diode switching circuit 18. With a switching operation by the laser diode switching circuit 18, the device is controlled so that a drive signal for allowing a laser ray L1 to be emitted from the laser diode 3 is output from the laser diode driver circuit 17.

A recording operation is performed in this state. In this case, through a control operation of the pickup controller circuit 13, a focus control operation is applied to focus the laser ray L1 in the first signal layer 1B and a tracking control operation is applied so that the laser ray L1 follows a groove which is called a “pregroove” formed in the first signal layer 1B of the optical disk 1. A movement of the body of the optical pickup device 2 associated with the tracking operation is realized by rotationally driving the pickup feeding motor 10. The digital signal processor circuit 14 applies operations such as extraction of the synchronization signal from a wobble signal obtained from the pregroove. This control is known in the art and will not be described in detail.

When a signal is to be recorded to the optical disk 1, the laser power is set to a value which is suitable for recording a signal onto the first signal layer 1B provided in the optical disk 1, and a drive signal for obtaining the laser ray of set power is supplied from the laser diode driver circuit 17 to the laser diode 3. The spindle motor driver circuit 19 rotationally controls the spindle motor 6 using the synchronization signal obtained from the wobble signal to rotationally drive the optical disk 1 at a desired constant linear speed.

In this state, a data signal which is a recording signal output from the host device is temporarily stored in the buffer memory equipped in the system controller circuit 15 and is then read and input to the signal recording circuit 16. When the data signal is input to the signal recording circuit 16, an encoding process for the data signal is performed by the signal recording circuit 16. As a result, a signal which is converted based on the recording signal is output as a pulse signal.

A pulse signal corresponding to the recording signal output from the signal recording circuit 16 is input to the laser diode driver circuit 17. The laser diode driver circuit 17 outputs a drive signal corresponding to the pulse signal to the laser diode 3. When the drive signal is supplied to the laser diode 3, a laser ray L1 is emitted from the laser diode 3 and irradiated onto the first signal layer 1B. In this manner, it is possible to record a data signal in the first signal layer 1B provided in the optical disk 1.

The recording operation of data signal to the first signal layer 1B is performed as described above. Formation of a visible image in the second signal layer 1D will now be described.

When a visible image is to be formed in the second signal layer 1D provided in the optical disk 1, the system control circuit 15 applies a control operation to the laser diode switching circuit 18. With the switching operation by the laser diode switching circuit 18, the device is controlled such that a drive signal for allowing a laser ray L2 to be emitted from the laser diode 3 is output from the laser diode drier circuit 17.

A visible image is formed in this state. During this process, a focusing control is applied for focusing the laser ray L2 in the second signal layer 1D through a control operation by the pickup controller circuit 13. Movement of the body of the optical pickup device 2 for forming the visible image is realized by rotationally driving the pickup feeding motor 10.

In addition, when a visible image is to be formed in the second signal layer 1D of the optical disk 1, the laser power is set to a value suitable for formation of a visible image in the second signal layer 1D of the optical disk 1 and a drive signal for obtaining a laser ray of the set power is supplied from the laser diode driver circuit 17 to the laser diode 3. The rotational control operation of the spindle motor 6 is performed by the spindle motor driver circuit 19 such that the angular speed is constant.

In this state, a visible image data signal for a visible image output from the host device is temporarily stored in the buffer memory equipped in the system controller circuit 15 and is then read and input to the signal recording circuit 16. When the visible image data signal is input to the signal recording circuit 16, a signal for forming a visible image is output from the signal recording circuit 16 as a pulse signal.

A pulse signal output from the signal recording circuit 16 corresponding to a visible image data signal is input to the laser diode driver circuit 17 and a drive signal corresponding to the pulse signal is output from the laser diode driver circuit 17 to the laser diode 3. When the drive signal is supplied to the laser diode 3, a laser ray L2 is emitted from the laser diode 3 and irradiated onto the second signal layer 1D. The position of the portion of the second signal layer 1D which is irradiated by the laser ray L2 is controlled by movement of the optical pickup device 2 by the pickup feeding motor 10 and displacement of the objective lens 4 is controlled by the tracking coil 9.

By controlling the position and timing of application of the laser ray L2 in this manner, it is possible to form a visible image in the second signal layer 1D of the optical disk 1. More specifically, it is possible to form, for example, a visible image indicating information regarding contents of the data signal recorded in the first signal layer 1B. The visible image formed in this manner may be formed so as to be visible from the side of the optical disk on the light incident surface or to be visible from the opposite side. In this process, it is necessary to configure the apparatus so that a visible image data signal corresponding to the direction of observation is output from the signal recording circuit 16.

As a technique for forming a visible image on an optical disk as described, a technique is known, for example, as described in Japanese Patent Laid-Open Publication No. 2002-203321. Using the technique described in this publication, it is possible to form a visible image in the second signal layer 1D which is provided as a recording layer.

Because it is possible to form a visible image such as text which indicates the contents or the like of the recorded data signal when a recording operation to the optical disk is completed, there is no necessity for flipping over the optical disk or the like, which is very convenient. In addition, because the visible image is recorded in the second signal layer, it is possible to form the visible image indicating the contents of the data signals recorded in the first signal layer over the entire region of the second signal layer.

Furthermore, because the visible image formed in the second signal layer can be viewed either from the light incident surface or from the opposite surface, it is possible to easily check the contents of the data signals recorded on the optical disk.

The second signal layer 1D which is provided as a signal recording layer may be provided as a recording layer in which only the visible image can be formed, or, alternatively, may be formed as a recording layer to which a data signal may be recorded. In this case, the standard for the signal to be recorded in the first signal layer 1B would differ from the standard for the signal to be recorded in the second signal layer 1D. For example, it is possible to configure such that the recording standard for the first signal layer 1B is the DVD standard and the recording standard for the second signal layer 1D is the CD standard.

It is also possible to configure such that the first signal layer 1B is a read-only signal layer and the second signal layer 1D is a signal layer dedicated to formation of the visible image, or such that the first signal layer 1B is a recording layer of the data signal and the second signal layer 1D is a recording layer in which the data signal is recorded and the visible image is formed. Moreover, it is also possible to configure such that the first signal layer 1B is a recording layer in which data signals are repeatedly recorded and the second signal layer 1D is a recording layer in which the data signals are repeatedly recorded and the visible images are repeatedly formed.

Because a recording operation of the data signal into the second signal layer is allowed, it is possible to record many data signals.

The optical disk 1 as described is a disk in which a visible image can be formed in one color. Next, an optical disk in which a visible image can be formed with a plurality of colors will be described referring to FIG. 3.

In the structure shown in FIG. 3, a second signal layer 1D includes three layers, that is, a blue emissive layer B, a green emissive layer G, and a red emissive layer R. In this case, the second signal layer 1D is a layer dedicated to formation of the visible image and a visible image separate for each color can be formed by controlling the layer to which the laser ray L2 is to be focused, among the blue emissive layer B, the green emissive layer G, and the red emissive layer R. In addition, by controlling a combination of layers to emit light, it is possible to synthesize various colors.

As described, because the second signal layer includes a plurality of layers which emit light of different colors, it is possible to form a colorful visible image.

1. An optical disk to which a laser ray, irradiated from an optical pickup device equipped in an optical disk recording and replaying apparatus, is incident, the optical disk comprising:
two signal layers including a first signal layer and a second signal layer formed from a light incident surface side, wherein
a visible image can be formed in the second signal layer using a laser ray irradiated from the side of the light incident surface.

2. An optical disk according to claim 1, wherein
a data signal can be recorded in the second signal layer.

3. An optical disk according to claim 1, wherein
the visible image which is formed in the second signal layer can be viewed from the light incident surface side and a surface opposite to the light incident surface.

4. An optical disk according to claim 1, wherein
the second signal layer comprises a plurality of layers which emit light of different colors.

5. An optical disk according to claim 1, wherein
a data signal can be recorded in the first signal layer.
